(19) United States
(12) Patent Application Publication
(10) Pub. No.: US 2008/0123059 A1
(43) Pub. Date: May 29, 2008

(54) Optical Projection System and Projection Device Having the Same

(75) Inventors: Tetsuya ABE, Hokkaido (JP); Ken AGATSUMA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/771,073

(22) Filed: Jun. 29, 2007

(30) Foreign Application Priority Data
Jun. 30, 2006 (JP) 2006-180939

(51) Int. Cl. G02B 27/18; G02B 13/18

(52) U.S. Cl. 353/70; 359/736; 359/728

(57) ABSTRACT

There is provided an optical projection system which includes a display device, a first optical system that has a positive power in total and has a first lens group and a second lens group, a second optical system having a reflective surface having a negative power, and a first deflecting system that directs a light beam emerging from the first optical system to the second optical system. The first lens group and the second lens group have a positive power and a negative power, respectively. The first deflecting system is located over the first optical system in a cross sectional plane. The first deflecting system deflects the light beam in a direction moving away from the screen to direct the light beam to the second optical system. The optical projection system satisfies conditions:

6.0>D/f1>2.6

−1>EXP1/f1>−2.2

### BACKGROUND OF THE INVENTION

The present invention relates to an optical projection system and a projection device configured to project an image formed by a display device obliquely onto a screen.

Projection devices configured to project an image formed by a display device obliquely onto a screen without causing trapezium distortion have been proposed. An example of such a projection device is disclosed in Japanese Patent Provisional Publication No. 2002-207190 (hereafter, referred to as JP2002-207190A). The projection device disclosed in JP2002-207190A is configured such that an image is projected onto a screen from the rear side and the image can be observed from the front side of the screen. In this projection device, a necessary optical path length is secured through use of a plurality of mirrors.

Such a configuration of the projection device requires optical components to be arranged such that the optical components do not interfere with an optical path which is folded a plurality of times by some of the optical components. Therefore, it is necessary to increase the size of the projection device to increase the degree of freedom of arrangement of the optical components.

The above mentioned drawback of the projection device may be solved by employing an aspherical mirror having the function of effectively scaling up the image to be projected while reducing aberrations such as trapezium distortion. In addition, it is desirable that the aspherical mirror is placed at a position as near to the screen as possible. However, if the aspherical mirror is placed at a position near to the screen, the size of the projection device is inevitably increased. It should be noted that if a designer tries to place the aspherical mirror at a suitable position in the projection device disclosed in JP2002-207190A of which degree of freedom of arrangement of optical components is relatively low, the size of the projection device is inevitably increased.

### SUMMARY OF THE INVENTION

The present invention is advantageous in that it provides an optical projection system and a projection device capable of achieving the downsizing of the device while employing an aspherical mirror.

According to an aspect of the invention, there is provided an optical projection system for a rear projection type projection device. The optical projection system includes a display device having a rectangular display area forming an image to be projected on a screen of the projection device, a first optical system that has a positive power in total and has a first lens group and a second lens group arranged in this order from a display device side, a second optical system having a reflective surface having a negative power, and a first deflecting system that directs a light beam emerging from the first optical system to the second optical system. The first lens group and the second lens group have a positive power and a negative power, respectively. In this configuration, the first deflecting system is located over the first optical system in a cross sectional plane including a first axis extending in a vertical direction in a normal use state of the projection device and passing through a center of the screen and including a second axis intersecting perpendicularly with the screen and passing through the center of the screen. The first deflecting system deflects the light beam in a direction moving away from the screen to direct the light beam to the second optical system.

Further, the optical projection system satisfies conditions:

6.0>D/f1>2.6

−1>EXP1/f1>−2.2

where D represents a distance between a rearmost surface of the first optical system and the second optical system, f1 represents a focal length of the first optical system, and EXP1 represents a distance between the rearmost surface of the first optical system and an exit pupil of the first optical system.

The above mentioned configuration of the optical projection system makes it possible to downsize the projection device or reduce the thickness of the projection device while suitably correcting aberrations such as distortion.

Optionally, the display device and at least a part of the first optical system may be located along a longitudinal direction of the screen. In this case, the optical projection system may further include a second deflecting system that deflects the light beam emerging from the at least a part of the first optical system.

Optionally, the optical projection system may satisfy a condition:

−1.2<f1/f1b<−0.8

where f1b represents a focal length of the second lens group.

Optionally, the optical projection system may satisfy a condition:

2>L1b/f1>0.7

where L1b represents a distance between the rearmost surface of the first tens group and a rearmost surface of the second lens group.

Optionally, the optical projection system may include a third deflecting system that directs the light beam emerging from the second optical system to the screen.

Optionally, the third deflecting system may be positioned to satisfy a condition:

75°<θ<86°

where θ represents an angle which a normal to the third deflecting system forms with respect to a normal to the screen.

Optionally, the reflective surface of the second optical system may be formed to be a rotationally-symmetrical aspherical surface.

Optionally, a rotation axis of the rotationally-symmetrical aspherical surface of the second optical system coincides with an optical axis of the first optical system when an optical path of the, optical projection system is developed.

According to another aspect of the invention, there is provided an optical projection system for a rear projection type projection device. The optical projection system includes a display device having a rectangular display area forming an image to be projected, a first optical system that has a positive power in total and has a first lens group and a second lens group arranged in this order from a display device side, a second optical system having a reflective surface having a negative power, and a first deflecting system that directs a light beam emerging from the first optical system to the second optical system. The first lens group and the second lens group have a positive power and a negative power, respectively. In this configuration, the first lens group includes a third lens group having a positive power, a fourth lens group having a positive power, and an aperture stop located between the third and fourth lens groups. When an optical path of the projection device is developed, a rotation axis of the first optical system formed to be rotationally-symmetrical about the rotation axis of the first optical system coincides with a rotation axis of the second optical system formed to be rotationally-symmetrical about the rotation axis of the second optical system. The optical projection system is configured to satisfy conditions:

50°<W1<70°<W2

6.0>D/f1>2.6

−1.2<f1/f1b<−0.8

−0.9<f2/f1<−0.2

ft>0

where W1 represents a minimum incident angle of right rays incident on the screen, W2 represents a maximum incident angle of the right rays incident on the screen, D represents a distance between a rearmost surface of the first optical system and the second optical system, f1 represents a focal length of the first optical system, f1b represents a focal length of the second lens group, f2 represents a focal length of the second optical system, and ft represents a total focal length of the second lens group and the fourth lens group.

The above mentioned configuration of the optical projection system makes it possible to downsize the projection device or reduce the thickness of the projection device while suitably correcting aberrations such as distortion.

With regard to the above mentioned two aspects of the invention, the first optical system may be configured to be a telecentric system on the display device side.

According to another aspect of the invention, there is provided a projection device which includes a light source; the above mentioned optical projection system, and the screen onto which the image formed by the display device of the projection optical system is projected in such a manner that the light beam from the projection optical system proceeds to the screen in a slanting direction from a rear side in the projection device. A light beam emitted by the light source enters the projection optical system.

### BRIEF DESCRIPTION OF THE ACCOMPANYING DRAWINGS

FIG. 1 is a cross sectional view of a projection device according to an embodiment of the invention in an X-Y plane.

FIG. 2 is a cross sectional view of a projection device according to an embodiment of the invention in an Y-Z plane.

FIG. 3 is an enlarged view of a part of the optical projection system in a state where an optical path is developed.

FIGS. 4A and 4B illustrate a configuration of a projection device formed as a variation of the projection device shown in FIGS. 1 and 2.

FIG. 5 shows a lens arrangement of a first optical system of an optical projection system according to a first example.

FIGS. 6A and 6B show astigmatism and distortion caused in the optical projection system according to the first example.

FIG. 7 shows a lens arrangement of a first optical system of an optical projection system according to a second example.

FIGS. 8A and 8B show astigmatism and distortion caused in the optical projection system according to the second example.

FIG. 9 shows a lens arrangement of a first optical system of an optical projection system according to a third example.

FIGS. 10A and 10B show astigmatism and distortion caused in the optical projection system according to the third example.

FIG. 11 shows a lens arrangement of a first optical system of an optical projection system according to a fourth example.

FIGS. 12A and 12B show astigmatism and distortion caused in the optical projection system according to the fourth example.

FIG. 13 shows a lens arrangement of a first optical system of an optical projection system according to a fifth example.

FIGS. 14A and 14B show astigmatism and distortion caused in the optical projection system according to the fifth example.

FIG. 15 is an enlarged view of a part of an optical projection system according to the fifth example in a state where an optical path is developed.

### DETAILED DESCRIPTION OF THE EMBODIMENTS

Hereinafter, an embodiment according to the invention is described with reference to the accompanying drawings.

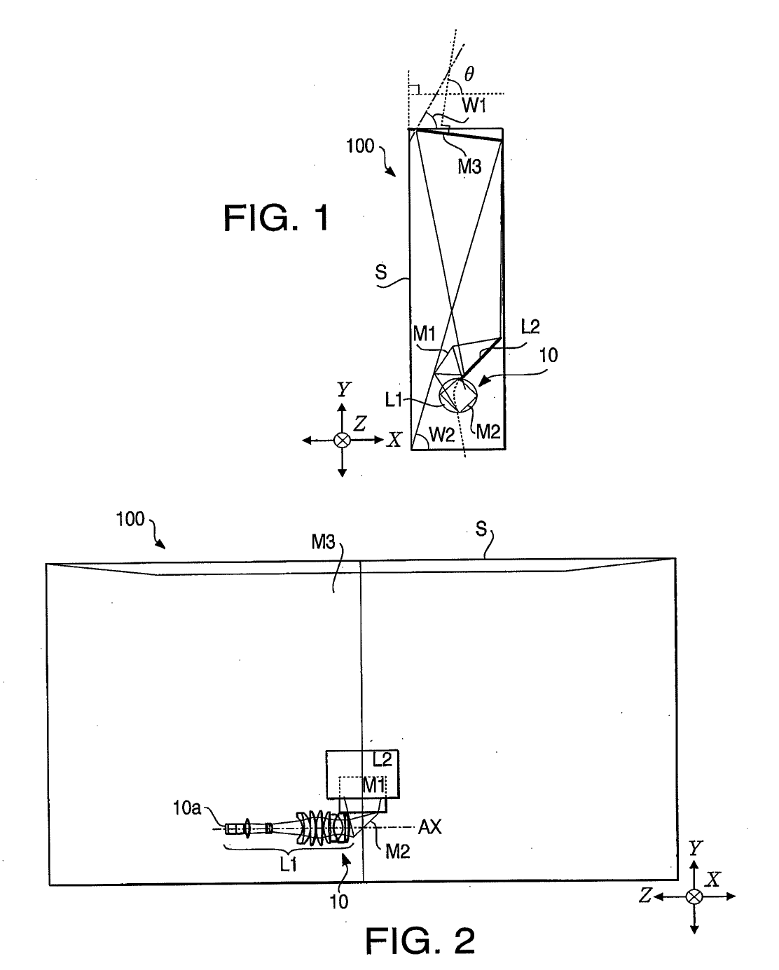

A configuration of a projection device 100 according to an embodiment is illustrated generally in FIGS. 1 and 2. In the followings, a state where the projection device 100 is placed on a horizontal plane is referred to as a normal use state. In the normal use state, a direction corresponding to the thickness of a screen S is defined as an X-direction, a vertical direction (a direction of the height of the device 100) is defined as a Y-direction, and a horizontal direction corresponding to the width of the device 100 is defined as a Z-direction.

In FIGS. 1 and 2, the projection device 100 is in the normal use state. More specifically, FIG. 1 is a cross-sectional view of the projection device 100 in an X-Y plane which includes an axis extending in the Y-direction and passing through the center of the screen S and which includes an axis perpendicularly intersecting with the screen S at the center of the screen S. FIG. 2 is a cross-sectional view of the projection device 100 in an Y-Z plane including an axis extending in the Z-direction and passing through the center of the screen S.

As shown in FIGS. 1 and 2, the projection device 100 includes the screen S and an optical projection system 10. The optical projection system 10 includes a first optical system L1, a second optical system L2, a first mirror M1, a second mirror M2, and a third mirror M3. The first optical system L1 is positioned such that an optical axis thereof is in parallel with the Z-axis. The first optical system L1 has positive power in total, and is configured to direct a light beam, which has been emitted by a light source (not shown) and has passed through a display device 10a, to the second mirror M2 while letting the light beam emerge from the first optical system L1 as a diverging beam.

The second mirror M2 deflects the light beam emerging from the first optical system L1 to the first mirror M1. The first mirror M1 deflects the light beam (which is reflected by the second mirror M2) in a direction moving away from the screen S and directs the light beam to the second optical system L2. As shown in FIG. 1, in the cross section in the X-Y plane, the screen S, the first mirror M1 and the second mirror M2 are placed in this order from the front side. In this embodiment, the second optical system L2 is formed of a single rotationally-symmetrical aspherical mirror having negative power. The second optical system L2 has the function of deflecting the incident light beam toward the third mirror M3 placed on the upper side of the projection device 100 while correcting aberrations which have not been corrected by the first optical system L1.

The second optical system L2 is positioned such that an optical path which is defined, between the second optical system L2 and the third mirror M3, for a light ray (hereafter, referred to as “a lowermost incident ray”) entering finally the lowermost position of the screen S becomes substantially parallel with the screen S. By thus forming the projection device 100 so that the lowermost incident ray is substantially parallel with the screen S, it is possible to minimize the distance between the second optical system L2 and the rear surface (i.e., a surface opposite to the screen S) of the projection device 100. Consequently, it becomes possible to decrease the size of the projection device in the X-direction (i.e., it is possible to reduce the thickness of the projection device 100).

The third mirror M3 is attached to the top wall of the projection device 100 to form a predetermined angle (i.e., an acute angle) with respect to the screen S. That is, the third mirror M3 is positioned to tilt with respect to the screen S. The light beam reflected by the third mirror 3 projects an image on the rear surface of the screen S. In this embodiment, the third mirror M3 is positioned to satisfy the following condition (1):

50°<W1<70°<W2 (1)

where W1 represents an incident angle (unit: degree) which a light ray (hereafter, referred to as “an uppermost incident ray”), which is a part of the light beam reflected from the mirror M3 and will enter the uppermost position of the screen S, forms with respect to the screen S, and W2 represents an incident angle which the lowermost incident ray forms with respect to the screen S. In the following, angles are represented by the unit degree.

By satisfying the condition (1), it is possible to decrease a ratio of the total volume of the light beam reflecting from the third mirror M3 and proceeding to the screen S while increasing the size of the image projected on the screen S. Consequently, the downsizing (i.e., the reduction of the thickness) can be achieved. In this embodiment, the condition (1) is satisfied by setting an angle θ, which the normal to the third mirror M3 forms with respect to the normal to the screen S, within an angle range of 75°<θ<86°. The angle θ corresponds to an angle which the screen S forms with respect to the third mirror M3.

On the screen S, a Fresnel lens is mounted. By the function of the Fresnel lens, the light beam impinging obliquely on the screen S proceeds from the front surface of the screen S in a direction substantially perpendicular to the screen S.

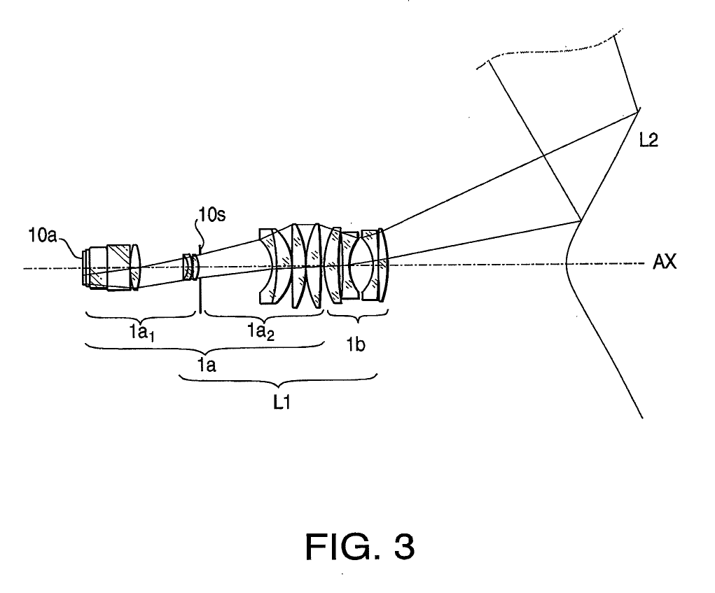

The projection optical system 10 will now be described. FIG. 3 is an enlarged view of a part of the projection device 100 illustrating in detail a configuration of the projection optical system 10. In FIG. 3, an optical path between the first optical system L1 and the second optical system L2 is developed and the first and second mirrors M1 and M2 are omitted for the sake of simplicity. As shown in FIG. 3, the first optical system L1 includes a first lens group 1a and a second lens group 1b in this order from the display device 10a side. The first lens group 1a includes an aperture stop 10s and has a positive power in total. The second lens group 1b has a negative power in total. The first lens group 1a is divided into a lens group 1a1 located on the display device 10a side and a lens group 1a2 located on the second lens group 1b side. The lens group 1a1 and the lens group 1a2 are separated by a boundary position defined by the aperture stop 10s. Each of the lens groups 1a1 and 1a2 has a positive power.

As described above, the second optical system L2 is formed to be a rotationally-symmetrical aspherical mirror surface (see FIG. 3). As shown in FIG. 3, when the optical path between the first and second optical systems L1 and L2 is developed, rotation centers of the first and second optical systems L1 and L2 are positioned on the common axis (i.e., on an optical axis AX of the first optical system L1). The first optical system L1 is configured to be a telecentric system on the display device 10a side. That is, by locating the aperture stop 10s in the vicinity of the back focus of the lens group 1a1 (which is located on the display device 10a side with respect to the aperture stop 10s), chief rays of the off-axis light proceeding in the vicinity of the display device 10a become substantially parallel with the optical axis AX.

As shown in FIG. 3, the second optical system L2 has a curved surface configured such that the curved surface has a relatively large angle of inclination in the vicinity of a position at which the right ray (i.e., the uppermost incident ray) emerging from the first optical system at the minimum exit angle impinges on the curved surface and that the angle of inclination becomes smaller at a position closer to the periphery of the curved surface. The curved surface (i.e., the aspherical surface) is configured to suitably correct distortion which is caused when a relatively narrow region is used for the light beam in a wide-angle side in the first optical system L1.

The optical projection system 10 is configured to satisfy the following conditions (2) and (3):

6.0>D/f1>2.6 (2)

−1>EXP1/f1>−2.2 (3)

where D represents a distance between the rearmost surface of the first optical system L1 and the second optical system L2, f1 represents a focal length of the first optical system L1, EXP1 represents a distance between the rearmost surface of the first optical system L1 and an exit pupil of the first optical system L1.

The above described condition (2) is a condition defined, in regard to distance D, to secure space for arranging the mirror M1 while maintaining the thin shape of the projection device 100. If D/f1 gets lower than or equal to the lower limit of the condition (2), i.e., if distance D is too short, it becomes impossible to secure sufficient space for the mirror M1 in the projection device 100. If D/f1 gets larger than or equal to the upper limit of the condition (2), i.e., if the distance D becomes too long, the second optical system L2 becomes larger than a required size. Therefore, it is desirable to satisfy the condition (2).

The condition (3) is a condition concerning the position of the exit pupil of the first optical system L1. By satisfying the condition (3), it is possible to define the height of the light beam proceeding in the vicinity of the rearmost surface of the optical system L1 from the optical axis AX, to avoid increase of the size of the projection device 100, and to reduce the thickness of the projection device 100 while securing a necessary field angle. If EXP1/f1 gets lower than or equal to the lower limit of the condition (3), the distance between the rearmost surface of the first optical system L1 and the exit pupil becomes too large. In this case, the diameter of a lens located in the vicinity of the rearmost surface in the first optical system L1 becomes too large. If EXP1/f1 gets larger than or equal to the upper limit of the condition (3), the position of a peripheral part of the light beam proceeding in the vicinity of the rearmost surface of the first optical system L1 becomes too near to the optical axis AX. In this case, the function of correcting the aberrations such as distortion or a coma to be achieved by lens surfaces in the vicinity of the rearmost surface of the first optical system L1 can not be effectively derived.

The optical projection system 10 may be configured to satisfy a condition (4):

−1.2<f1/f1b<−0.8 (4)

where f1b represents a focal length of the second lens group 1b.

In general, a projection device of a rear projection type having a display device (i.e., the display device 10a) is configured such that a color combining (or separating) device (e.g., a dichroic prism) for separating or combining color components of a light beam is placed directly behind the display device. The condition (4) is a condition to be satisfied to secure space for accommodating a color combining (or separating) device between the display device 10a and the forehand surface of the first optical system L1. By satisfying the condition (4), the first optical system L1 has a negative power in the vicinity of the rearmost surface thereof. Consequently, it becomes possible to bring a principal point of the first optical system L1 close to the display device 10a, and to secure space for accommodating a color combining (or separating) device between the forehand surface of the first optical system L1 and the display device 10a.

If f1/f1b gets lower than or equal to the lower limit of the condition (4), the negative power of the second lens group 1b becomes too weak. In this case, the distance between the display device 10a and the forehand surface of the first optical system L1 becomes too small. If f1/f1b gets larger than or equal to the upper limit of the condition (4), the negative power of the second lens group 1b becomes too strong. In this case, the positive distortion or coma becomes too large, and thereby the quality of an image to be projected on the screen S deteriorates.

The optical projection system 10 may be configured to satisfy a condition (5):

2>L1b/f1>0.7 (5)

where L1b represents a distance between the rearmost surface of the first lens group 1a and the rearmost surface of the second lens group 1b.

The condition (5) is a condition to be satisfied to appropriately define the power distribution for the second lens group 1b. If L1b/f1 gets lower than or equal to the lower limit of the condition (5), the total length of the second lens group 1b becomes too small. In this case, it is necessary to reduce the number of lenses to be included in the second lens group 1b. In other words, a power to be achieved by one lens in the second lens group 1b becomes too large. In this case, a relatively large off-axis aberration such as a coma may be caused and thereby the imaging quality deteriorates.

If L1b/f1 gets larger than or equal to the upper limit of the condition (5), the total length of the second lens group 1b becomes too large. In this case, relatively large space is required to accommodate the entire part of the first optical system L1. That is, in this case, the size of the projection device 100 is inevitably increased.

As described above, according to the embodiment, the thickness of the projection device 100 can be reduced, and the entire size of the projection device 100 is substantially determined by the size of the screen S. In other words, the above mentioned configuration enables a designer to achieve a so-called frameless body design for the projection device 100.

When the above mentioned conditions (1), (2) and (4) are satisfied, the above mentioned advantages can also be achieved by satisfying the following conditions (6) and (7).

−0.9<f2/f1<−0.2 (6)

ft>0 (7)

The condition (6) is a condition concerning a power ratio between the first optical system L1 and the second optical system L2. The condition (7) is a condition concerning the total focal length ft of the lens group 1a2 and the second lens group 1b.

In general, the larger the negative power of the second optical system L2 becomes, the smaller an angle which the lowermost incident ray forms with respect to the optical axis AX becomes. Therefore, it is possible to reduce the effective diameter of each of the first and second optical systems L1 and L2. However, there is a possibility that a large amount of aberration is caused when the second optical system L2 is designed to have large power. Therefore, it is important to appropriately achieve a balance of power between power of the first optical system L1 and power of the second optical system L2. The condition (6) is determined in view of the above described circumstances.

More specifically, if f2/f1 gets lower than or equal to the lower limit of the condition (6), the power of the second optical system L2 becomes too small. In this case, the aperture of the second optical system L2 becomes too large, and the field angle of the first optical system L1 becomes larger than a required value.

If f2/f1 larger than or equal to the upper limit of the condition (6), the power of the second optical system L2 becomes excessively large. In this case, a considerable amount of aberration may be caused or it becomes impossible to correct the aberration remaining in the first optical system L1.

By determining the total focal length ft to be positive, it is possible to suppress a component of distortion caused in the first optical system L1 to a small level.

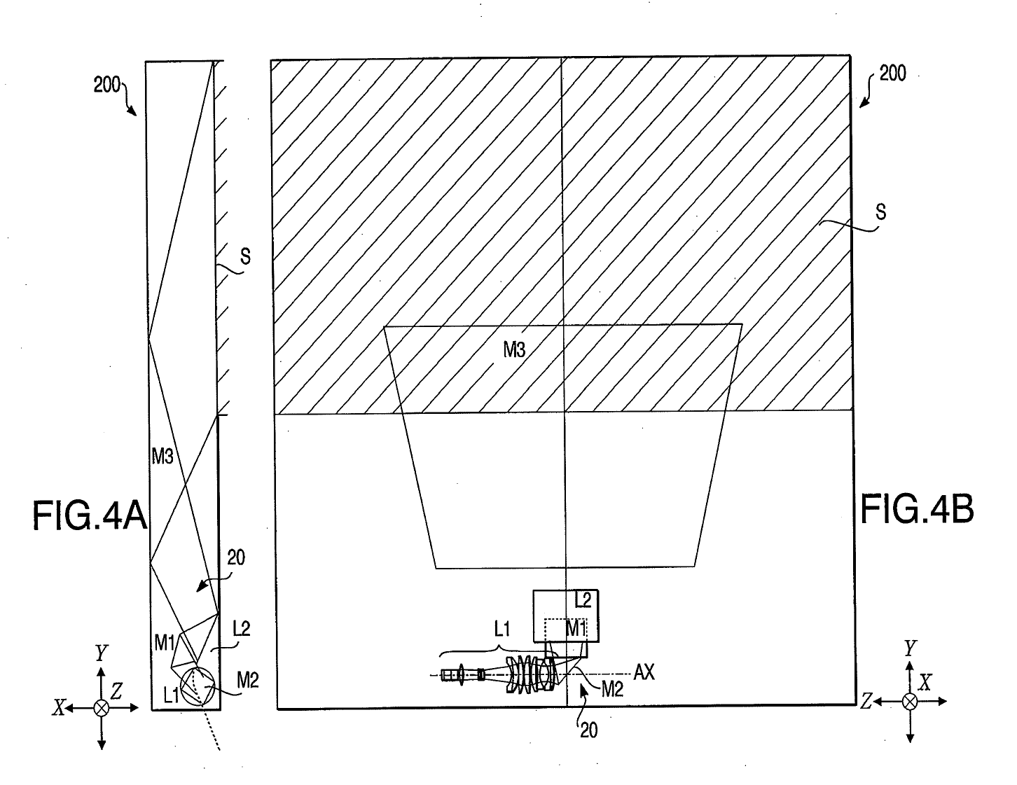

If the conditions (2) and (3) are satisfied, the positions of the components in the projection device 100 may be changed as shown, for example, in FIGS. 4A and 4B. FIGS. 4A and 4B illustrate a variation of the above mentioned projection device 100. FIG. 4A is a cross-sectional view of a projection device 200 along the X-Y plane including the center of the screen S. FIG. 4B is a cross-sectional view of the projection device 200 along the Y-Z plane including the center of the screen S. In FIGS. 4A and 4B, to elements which are substantially the same as those of the projection device 100, the same reference numbers are assigned and explanations thereof will not be repeated.

Similarly to the optical projection system 10, an optical projection system 20 has the first optical system L1, the second optical system L2, the first mirror M1, the second mirror M2, and the third mirror M3. In the optical projection system 20, the first optical system L1 and the second mirror M2 are arranged to have the same positions as those of the first optical system L1 and the second mirror M2 in the optical projection system 10. In contrast to the arrangement of the optical projection system 10, the third mirror M3 is mounted along the rear wall of the projection device 200. Such an arrangement of the third mirror M3 causes each of the first mirror M1 and the second optical system L2 to deflect the light beam in a direction opposite to the direction in which each of the first mirror M1 and the second optical system L2 deflects the light beam in the projection device 100.

According the configuration shown in FIGS. 4A and 4B, a so-called frameless body design can not be achieved because in this case a part of the optical projection system 20 is situated under the screen S. Therefore, the height of the projection device 200 (i.e., the size in Y-direction) is inevitably increased. However, according to the configuration shown in FIGS. 4A and 4B, the thickness (i.e., the size in X-direction) can be further reduced because the third mirror M3 is mounted on the rear wall of the projection device 200.

In the above mentioned configuration of each of the projection devices 100 and 200, the first optical system L1 is arranged along the Z-direction and the light beam emerging from the first optical system L1 is deflected toward the first mirror M1 by the second mirror M2. By thus arranging the first optical system L1, requiring a predetermined length to accommodate a plurality of optical components therein, along the direction corresponding to the width of the screen S (i.e., along the Z-direction), it is possible to reduce the thickness of the projection device and to decrease the total size of the projection device while achieving the space required to accommodate the first optical system L1. It should be noted that space having a relatively large length can be secured to accommodate the first optical system L1 because the width of the screen S is relatively large.

The first optical system L1 may be arranged differently from the above mentioned configurations depending on the internal configuration of the first optical system L1 or depending on arrangement of the components other than the first optical system L1. For example, the first optical system L1 may be arranged so that the light beam emerging from the first optical system L1 directly impinges on the first mirror M1 without using the second mirror M2.

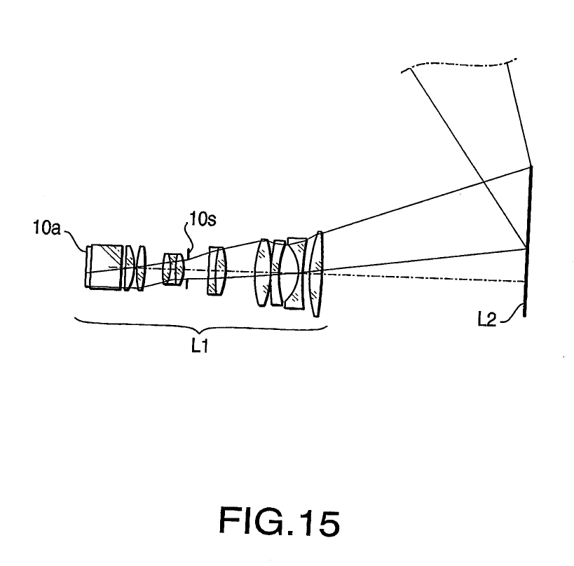

Hereafter, five concrete examples (first to five examples) of the optical projection system 10. FIG. 3 illustrates a configuration of each of the first and second optical systems L1 and L2 according to each of the first to fourth examples. FIG. 15 illustrates a configuration of the first and second optical systems L1 and L2 according to the fifth example.

### FIRST EXAMPLE

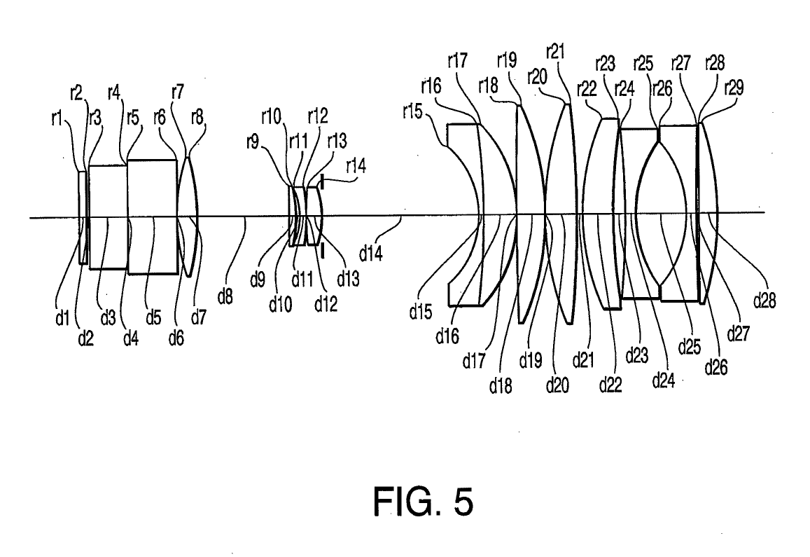

FIG. 5 shows a lens arrangement of the first optical system L1 of the optical projection system 10 according to the first example. Table 1 shows numeric specifications of the optical projection system 10 according to the first example.

TABLE 1

| Surface | | | | |
|---|---|---|---|---|
| No. | r | d | nd | νd |
| 1 | ∞ | 3.00 | 1.56883 | 56.4 |
| 2 | ∞ | 1.00 | | |
| 3 | ∞ | 15.00 | 1.56883 | 56.4 |
| 4 | ∞ | 0.50 | | |
| 5 | ∞ | 19.00 | 1.70154 | 41.2 |
| 6 | ∞ | 0.50 | | |
| 7 | 70.546 | 7.61 | 1.74320 | 49.3 |
| 8 | −73.204 | 37.93 | | |
| 9 | −188.489 | 2.41 | 1.49700 | 81.5 |
| 10 | −49.056 | 1.77 | | |
| 11 | −24.479 | 2.50 | 1.69895 | 30.1 |
| 12 | −59.232 | 0.20 | | |
| 13 | 884.295 | 6.15 | 1.49700 | 81.5 |
| 14 | −32.467 | 63.54 | | |
| 15 | −32.665 | 2.00 | 1.63980 | 34.5 |
| 16 | −216.783 | 13.19 | 1.65160 | 58.5 |
| 17 | −47.102 | 0.20 | | |
| 18 | 1611.243 | 11.40 | 1.71299 | 53.9 |
| 19 | −89.944 | 0.20 | | |
| 20 | 100.542 | 12.25 | 1.77250 | 49.6 |
| 21 | −361.105 | 2.31 | | |
| 22 | 81.026 | 12.00 | 1.80518 | 25.4 |
| 23 | 177.383 | 4.76 | | |
| 24 | −345.898 | 4.00 | 1.77250 | 49.6 |
| 25 | 43.113 | 20.27 | | |
| 26 | −39.829 | 4.00 | 1.77250 | 49.6 |
| 27 | 930.647 | 1.46 | | |
| 28 | −1419.807 | 7.00 | 1.49176 | 57.4 |
| 29 | −99.702 | 152.76 | | |
| 30 | 41.068 | — | | |

In Table 1 (and on the following similar Tables), “r” denotes the curvature radius (mm) of each optical surface, “d” denotes the distance (mm) from each optical surface to the next optical surface of the lens thickness, “nd” denotes the refractive index for d-ray, and “vd” denotes Abbe number for d-ray. In Table 1, surface Nos. 1 to 14 belong to the lens group 1a1, surface Nos. 15 to 21 belong to the lens group 1a2, surface Nos. 22 to 29 belong to the second lens group 1b, and surface No. 30 belongs to the second optical system L2. The aperture stop is located at a position 0.200 mm behind the surface No. 14. In the first example, the focal length of the optical projection system 10 is 2.94 mm, and the focal length of the first optical system L1 is 33.63 mm.

Each of the surfaces Nos. 8, 29 and 30 is configured to be a rotationally-symmetrical aspherical surface. A configuration of an aspherical surface can be expressed by the following expression:

$$X ( h ) = \frac{{Ch}^{2}}{1 + \sqrt{1 - ( K + 1 ) {C}^{2} {h}^{2}}} + {\sum }_{i = 2} {A}_{2 i} {h}^{2 i}$$

where X(h) denotes a SAG amount of a coordinate point on the aspherical surface whose height (distance) from the optical axis is h (SAG amount: distance measured from a tangential plane contacting the aspherical surface on the optical axis), “C” denotes the curvature (1/r) of the aspherical surface on the optical axis, “K” denotes a cone constant, and each “A₂ᵢ” (i: integer larger than 1) denotes an aspherical coefficient of the 2i-th order (the summation in the expression includes aspherical coefficients A₄, A₆, A₈, A₁₀, A₁₂, . . . of the fourth order, sixth order, eighth order, tenth order, twelfth order, and so forth).

The following Table 2 shows the cone constant and aspherical coefficients specifying the shape of each aspherical surface (8, 29, 30). Incidentally, the notation “E” in Table 2 (and in the following similar Tables) means the power of 10 with an exponent specified by the number to the right of E (e.g. “E-04” means “×10⁻⁴”).

TABLE 2

| Surface | | | |
|---|---|---|---|
| No. | K | A4 | A6 |
| 8 | 0.00000E+00 | 0.29989E−05 | −0.18087E−08 |
| 29 | 0.00000E+00 | 0.67241E+06 | −0.69884E−09 |
| 30 | −0.42161E+01 | −0.27487E−07 | 0.11891E−11 |
| Surface | | | |
| No. | A8 | A10 | A12 |
| 8 | 0.00000E+00 | 0.00000E+00 | 0.00000E+00 |
| 29 | 0.12620E−12 | 0.00000E+00 | 0.00000E+00 |
| 30 | −0.33064E−16 | 0.53221E−21 | −0.37395E−26 |

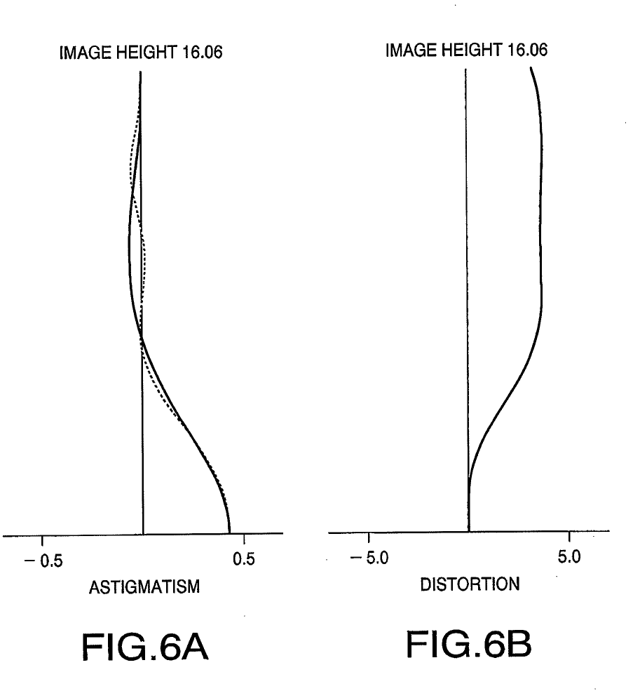

FIG. 6A is a graph illustrating astigmatism caused in the optical projection system 10 according to the first example. FIG. 6B is a graph illustrating distortion caused in the optical projection system 10 according to the first example. More specifically, each of FIGS. 6A and 6B (and the following similar drawings) shows aberration caused in the display device 10a when light enters the optical projection system 100 from the screen S side. In each of FIGS. 6A and 6B (and in the following similar Tables), a solid line represents a component of aberration in a sagittal cross section, and a dashed line represents a component of aberration in a meridional cross section.

### SECOND EXAMPLE

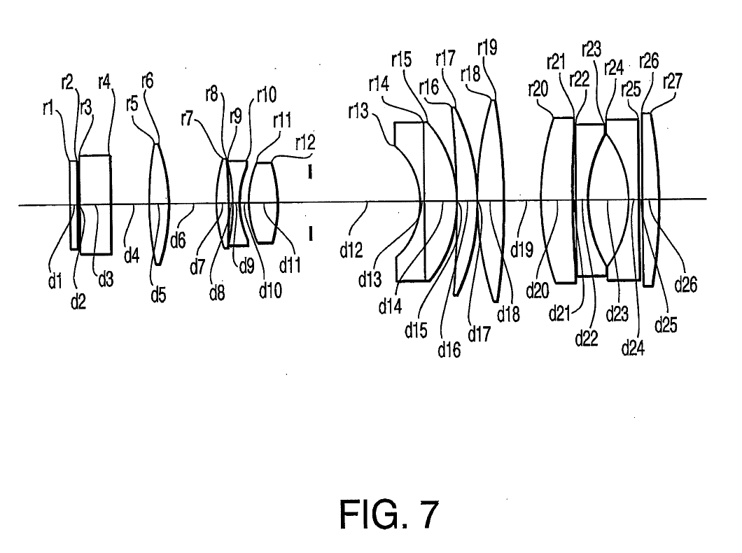

FIG. 7 shows a lens arrangement of the first optical system L1 of the optical projection system 10 according to the second example. Table 3 shows numeric specifications of the optical projection system 10 according to the second example.

TABLE 3

| Surface | | | | |
|---|---|---|---|---|
| No. | r | d | nd | νd |
| 1 | ∞ | 3.00 | 1.56883 | 56.4 |
| 2 | ∞ | 1.00 | | |
| 3 | ∞ | 12.00 | 1.48749 | 70.2 |
| 4 | ∞ | 15.05 | | |
| 5 | 123.226 | 7.51 | 1.74320 | 49.3 |
| 6 | −55.333 | 18.91 | | |
| 7 | 49.185 | 4.51 | 1.49700 | 81.5 |
| 8 | −214.861 | 1.99 | | |
| 9 | −55.252 | 2.50 | 1.60342 | 38.0 |
| 10 | 27.910 | 4.05 | | |
| 11 | 32.808 | 11.30 | 1.49700 | 81.5 |
| 12 | −47.888 | 56.60 | | |
| 13 | −24.165 | 2.00 | 1.64769 | 33.8 |
| 14 | −604.776 | 13.18 | 1.65160 | 58.5 |
| 15 | −38.737 | 0.20 | | |
| 16 | −234.873 | 7.80 | 1.71299 | 53.9 |
| 17 | −68.839 | 0.20 | | |
| 18 | 116.938 | 10.40 | 1.77250 | 49.6 |
| 19 | −188.594 | 14.75 | | |
| 20 | 95.389 | 12.00 | 1.80518 | 25.4 |
| 21 | 497.125 | 1.87 | | |
| 22 | −581.613 | 4.00 | 1.77250 | 49.6 |
| 23 | 46.091 | 16.23 | | |
| 24 | −37.572 | 4.00 | 1.77250 | 49.6 |
| 25 | −2752.424 | 1.00 | | |
| 26 | 25904.153 | 7.00 | 1.49176 | 57.4 |
| 27 | −120.281 | 185.14 | | |
| 28 | 50.752 | — | | |

In Table 3, surfaces Nos. 1 to 12 belong to the lens group 1a1, surfaces Nos. 13 to 19 belong to the lens group 1a2, surfaces Nos. 20 to 27 belong to the second lens group 1b, and surface No. 28 belongs to the second optical system L2. The aperture stop is located at a position 13.063 mm ahead of the surface No. 12. In the second example, the focal length of the optical projection system 10 is 3.16 mm, and the focal length of the first optical system L1 is 33.09 mm.

Each of the surfaces Nos. 6, 27 and 28 is configured to be a rotationally-symmetrical aspherical surface. The following Table 4 shows the cone constant and aspherical coefficients specifying the shape of each aspherical surface (6, 27, 28).

TABLE 4

| Surface | | | |
|---|---|---|---|
| No. | K | A4 | A6 |
| 6 | 0.00000E+00 | 0.14309E−05 | −0.84514E−09 |
| 27 | 0.00000E+00 | 0.11841E−05 | −0.50922E−09 |
| 28 | −0.43457E+01 | −0.20838E−07 | 0.77153E−12 |
| Surface | | | |
| No. | A8 | A10 | A12 |
| 6 | 0.00000E+00 | 0.00000E+00 | 0.00000E+00 |
| 27 | 0.10200E−12 | 0.00000E+00 | 0.00000E+00 |
| 28 | −0.18935E−16 | 0.27446E−21 | −0.17476E−26 |

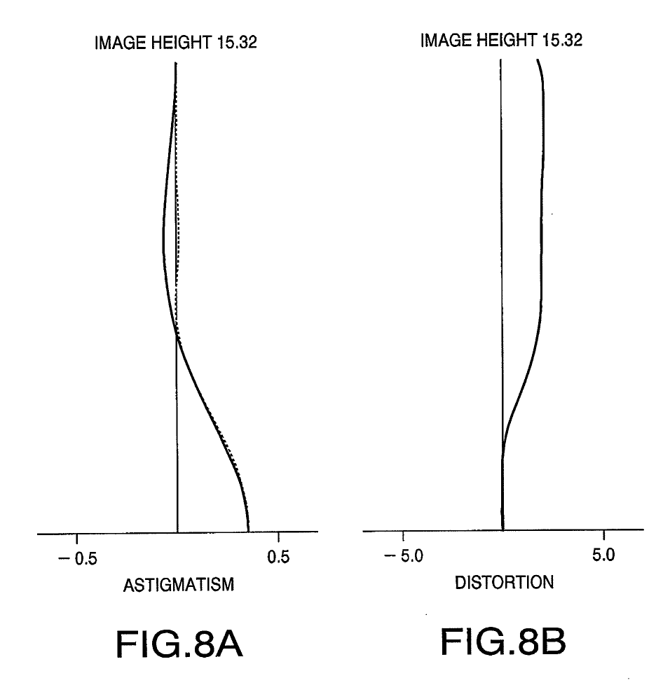

FIG. 8A is a graph illustrating astigmatism caused in the optical projection system 10 according to the second example. FIG. 8B is a graph illustrating distortion caused in the optical projection system 10 according to the second example.

### THIRD EXAMPLE

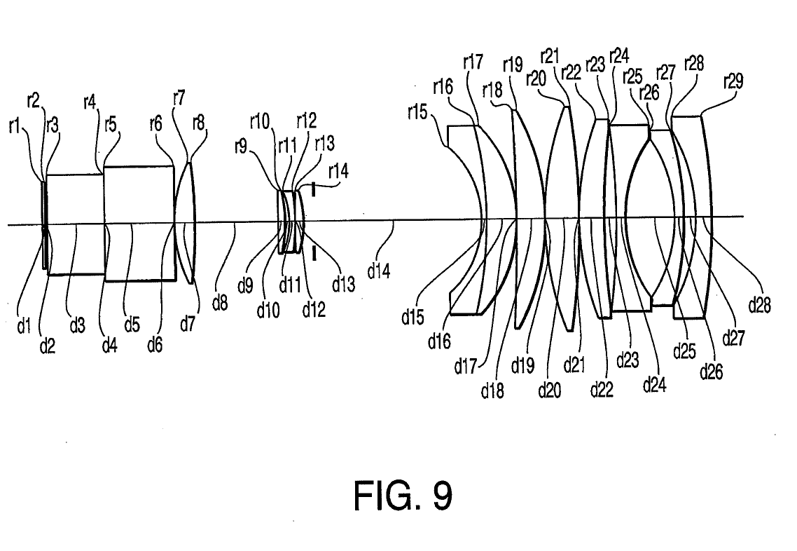

FIG. 9 shows a lens arrangement of the first optical system L1 of the optical projection system 10 according to the third example. Table 5 shows numeric specifications of the optical projection system 10 according to the third example.

TABLE 5

| Surface | | | | |
|---|---|---|---|---|
| No. | r | d | nd | νd |
| 1 | ∞ | 1.00 | 1.51633 | 64.1 |
| 2 | ∞ | 1.00 | | |
| 3 | ∞ | 25.00 | 1.70154 | 41.2 |
| 4 | ∞ | 0.50 | | |
| 5 | ∞ | 30.00 | 1.70154 | 41.2 |
| 6 | ∞ | 0.50 | | |
| 7 | 51.527 | 8.48 | 1.74320 | 49.3 |
| 8 | −149.232 | 36.58 | | |
| 9 | −201.142 | 2.56 | 1.49700 | 81.5 |
| 10 | −54.269 | 2.00 | | |
| 11 | −27.095 | 2.50 | 1.69895 | 30.1 |
| 12 | −66.812 | 0.20 | | |
| 13 | −511.239 | 3.48 | 1.49700 | 81.5 |
| 14 | −35.644 | 79.77 | | |
| 15 | −36.102 | 2.00 | 1.63980 | 34.5 |
| 16 | −141.842 | 13.07 | 1.65160 | 58.5 |
| 17 | −50.908 | 0.20 | | |
| 18 | −524.680 | 11.42 | 1.71299 | 53.9 |
| 19 | −87.325 | 0.20 | | |
| 20 | 105.856 | 14.65 | 1.77250 | 49.6 |
| 21 | −315.011 | 0.20 | | |
| 22 | 101.405 | 11.09 | 1.80518 | 25.4 |
| 23 | 293.752 | 5.13 | | |
| 24 | −309.593 | 4.00 | 1.77250 | 49.6 |
| 25 | 51.194 | 21.48 | | |
| 26 | −53.360 | 4.00 | 1.77250 | 49.6 |
| 27 | −117.396 | 5.50 | | |
| 28 | −63.676 | 7.00 | 1.49176 | 57.4 |
| 29 | −149.950 | 145.88 | | |
| 30 | 39.875 | — | | |

In Table 5, surfaces Nos. 1 to 14 belong to the lens group 1a1, surfaces Nos. 15 to 21 belong to the lens group 1a2, surfaces Nos. 22 to 29 belong to the second lens group 1b, and surface No. 30 belongs to the second optical system L2. The aperture stop is located at a position 4.747 mm behind of the surface No. 14. In the third example, the focal length of the optical projection system 10 is 3.10 mm, and the focal length of the first optical system L1 is 37.72 mm.

Each of the surfaces Nos. 8, 29 and 30 is configured to be a rotationally-symmetrical aspherical surface. The following Table 6 shows the cone constant and aspherical coefficients specifying the shape of each aspherical surface (8, 29, 30).

TABLE 6

| Surface | | | |
|---|---|---|---|
| No. | K | A4 | A6 |
| 8 | 0.00000E+00 | 0.27590E−05 | −0.11847E−08 |
| 29 | 0.00000E+00 | 0.11031E−05 | −0.43440E−09 |
| 30 | −0.41225E−01 | −0.28859E−07 | 0.12558E−11 |
| Surface | | | |
| No. | A8 | A10 | A12 |
| 8 | 0.00000E+00 | 0.00000E+00 | 0.00000E+00 |
| 29 | 0.69641E−13 | 0.00000E+00 | 0.00000E+00 |
| 30 | −0.34575E−16 | 0.54621E−21 | −0.37527E−26 |

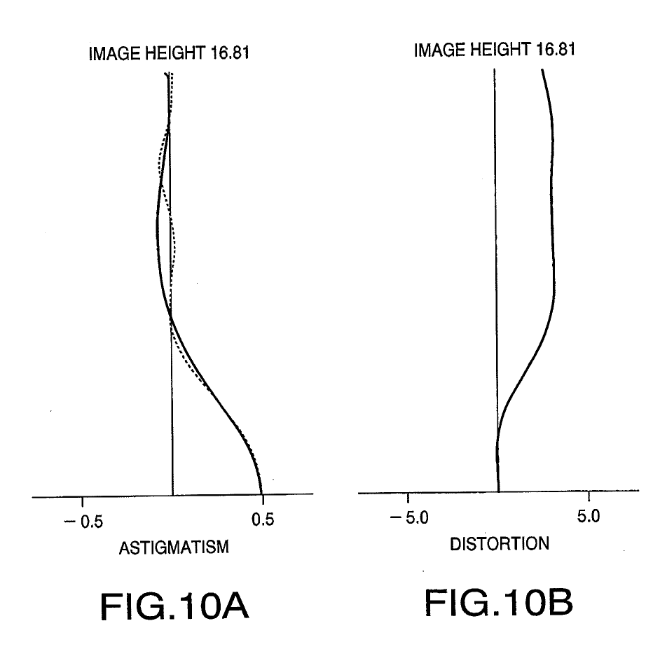

FIG. 10A is a graph illustrating astigmatism caused in the optical projection system 10 according to the third example. FIG. 10B is a graph illustrating distortion caused in the optical projection system 10 according to the third example.

### FOURTH EXAMPLE

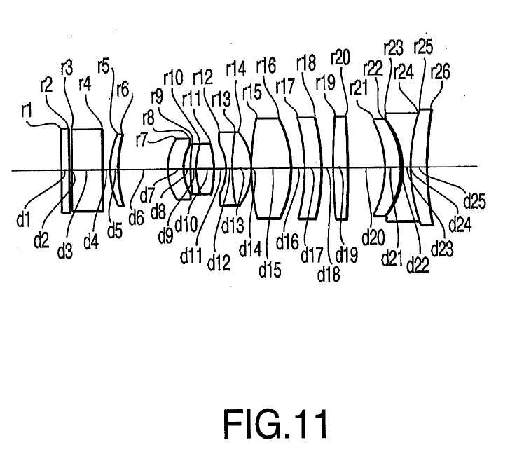

FIG. 11 shows a lens arrangement of the first optical system L1 of the optical projection system 10 according to the fourth example. Table 7 shows numeric specifications of the optical projection system 10 according to the fourth example.

TABLE 7

| Surface | | | | |
|---|---|---|---|---|
| No. | r | d | nd | νd |
| 1 | ∞ | 3.00 | 1.56883 | 56.4 |
| 2 | ∞ | 1.00 | | |
| 3 | ∞ | 12.00 | 1.48749 | 70.2 |
| 4 | ∞ | 3.10 | | |
| 5 | 30.796 | 3.00 | 1.58636 | 60.9 |
| 6 | 102.321 | 19.66 | | |
| 7 | 19.187 | 6.00 | 1.65844 | 50.9 |
| 8 | 16.033 | 3.01 | | |
| 9 | 95.037 | 2.00 | 1.56732 | 42.8 |
| 10 | 27.302 | 7.00 | 1.49700 | 81.5 |
| 11 | −34.950 | 4.84 | | |
| 12 | −15.674 | 2.00 | 1.56732 | 42.8 |
| 13 | 62.659 | 8.03 | 1.49700 | 81.5 |
| 14 | −19.848 | 0.20 | | |
| 15 | 88.409 | 15.85 | 1.58913 | 61.1 |
| 16 | −36.974 | 5.59 | | |
| 17 | −56.080 | 6.75 | 1.71299 | 53.9 |
| 18 | −62.911 | 4.93 | | |
| 19 | 155.250 | 6.00 | 1.77250 | 49.6 |
| 20 | −275.523 | 14.55 | | |
| 21 | −33.789 | 6.00 | 1.78472 | 25.7 |
| 22 | −27.486 | 0.67 | | |
| 23 | −25.766 | 3.00 | 1.71299 | 53.9 |
| 24 | 71.020 | 0.20 | | |
| 25 | 64.384 | 6.00 | 1.58636 | 60.9 |
| 26 | 116.286 | 95.80 | | |
| 27 | 30.431 | — | | |

In Table 7, surfaces Nos. 1 to 11 belong to the lens group 1a1, surfaces Nos. 12 to 20 belong to the lens group 1a2, surfaces Nos. 21 to 26 belong to the second lens group 1b, and surface No. 27 belongs to the second optical system L2. The aperture stop is located at a position 0.354 mm behind of the surface No. 11. In the fourth example, the focal length of the optical projection system 10 is 3.48 mm, and the focal length of the first optical system L1 is 30.68 mm.

Each of the surfaces Nos. 6, 26 and 27 is configured to be a rotationally-symmetrical aspherical surface. The following Table 8 shows the cone constant and aspherical coefficients specifying the shape of each aspherical surface (6, 26, 27).

TABLE 8

| Surface | | | |
|---|---|---|---|
| No. | K | A4 | A6 |
| 6 | 0.00000E+00 | 0.41947E−04 | 0.87613E−07 |
| 26 | 0.00000E+00 | 0.22490E−05 | −0.36300E−08 |
| 27 | −0.41757E+01 | −0.79723E−07 | 0.63263E−11 |
| Surface | | | |
| No. | A8 | A10 | A12 |
| 6 | −0.17746E−09 | 0.00000E+00 | 0.00000E+00 |
| 26 | 0.00000E+00 | 0.00000E+00 | 0.00000E+00 |
| 27 | −0.19971E−15 | 0.00000E+00 | 0.00000E+00 |

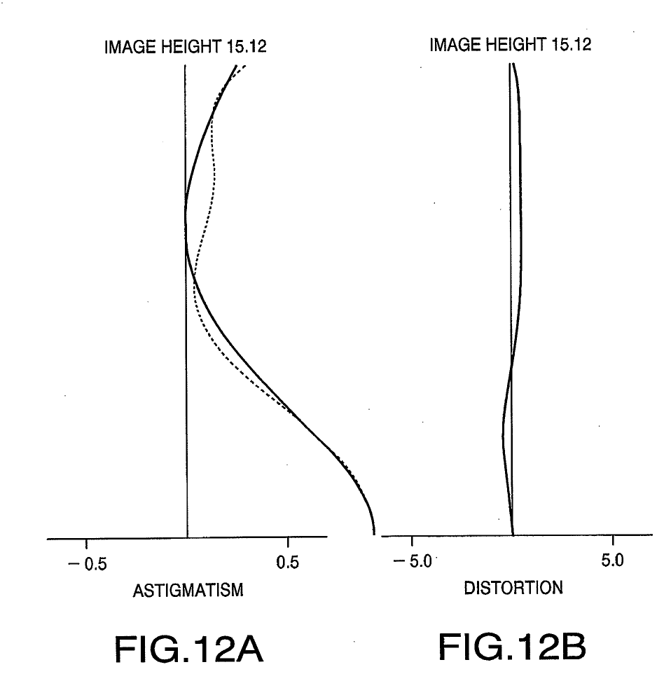

FIG. 12A is a graph illustrating astigmatism caused in the optical projection system 10 according to the fourth example. FIG. 12B is a graph illustrating distortion caused in the optical projection system 10 according to the fourth example.

### FIFTH EXAMPLE

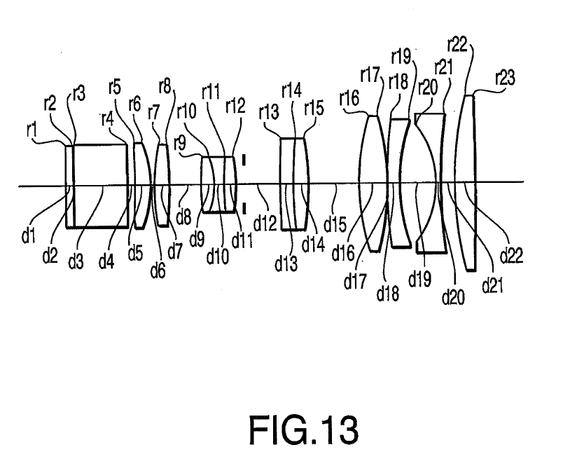

FIG. 13 shows a lens arrangement of the first optical system L1 of the optical projection system 10 according to the fifth example. In this example, a Fresnel mirror is used as the second optical system L2 in place of using an aspherical mirror. Therefore, it becomes possible to position the second optical system L2 to be substantially perpendicular to the optical axis AX. Consequently, the thickness of the projection device 100 can be further reduced. Table 9 shows numeric specifications of the optical projection system 10 according to the fifth example.

TABLE 9

| Surface | | | | |
|---|---|---|---|---|
| No. | r | d | nd | νd |
| 1 | ∞ | 3.00 | 1.48749 | 70.2 |
| 2 | ∞ | 0.50 | | |
| 3 | ∞ | 20.00 | 1.51633 | 64.1 |
| 4 | ∞ | 3.24 | | |
| 5 | −179.031 | 5.71 | 1.58913 | 61.1 |
| 6 | −39.419 | 1.60 | | |
| 7 | 73.316 | 5.54 | 1.49700 | 81.5 |
| 8 | −105.168 | 12.52 | | |
| 9 | 91.845 | 5.32 | 1.48749 | 70.2 |
| 10 | −23.673 | 3.75 | 1.83400 | 37.2 |
| 11 | 98.061 | 4.70 | 1.58913 | 61.1 |
| 12 | −48.018 | 17.83 | | |
| 13 | −934.328 | 4.94 | 1.80777 | 28.8 |
| 14 | 152.934 | 6.00 | 1.78019 | 45.7 |
| 15 | −77.118 | 20.62 | | |
| 16 | 90.674 | 10.80 | 1.83481 | 42.7 |
| 17 | −76.964 | 0.23 | | |
| 18 | 270.935 | 4.61 | 1.65160 | 58.5 |
| 19 | 64.180 | 14.47 | | |
| 20 | −30.473 | 1.63 | 1.62004 | 36.3 |
| 21 | 162.699 | 5.76 | | |
| 22 | 130.368 | 8.04 | 1.74400 | 44.8 |
| 23 | −198.388 | 139.93 | | |
| 24 | 35.754 | — | | |

In Table 9, surfaces Nos. 1 to 12 belong to the lens group 1a1, surfaces Nos. 13 to 17 belong to the lens group 1a2, surfaces Nos. 18 to 23 belong to the second lens group 1b, and surface No. 24 belongs to the second optical system L2. The aperture stop is located at a position 3.425 mm behind of the surface No. 12. In the fifth example, the focal length of the optical projection system 10 is 3.40 mm, and the focal length of the first optical system L1 is 39.46 mm.

Each of the surfaces Nos. 6 and 23 is configured to be a rotationally-symmetrical aspherical surface and the surface No. 24 is configured to be a Fresnel mirror. The following Table 10 shows the cone constant and aspherical coefficients specifying the shape of each aspherical surface (6, 23, 24).

TABLE 10

| Surface | | | |
|---|---|---|---|
| No. | K | A4 | A6 |
| 6 | −0.16931E−01 | 0.00000E+00 | 0.00000E+00 |
| 23 | 0.00000E+00 | 0.23248E−05 | −0.63825E−09 |
| 24 | −0.36609E+01 | −0.48811E−07 | 0.16185E−11 |
| Surface | | | |
| No. | A8 | A10 | A12 |
| 6 | 0.00000E+00 | 0.00000E+00 | 0.00000E+00 |
| 23 | 0.00000E+00 | 0.00000E+00 | 0.00000E+00 |
| 24 | 0.00000E+00 | 0.00000E+00 | 0.00000E+00 |

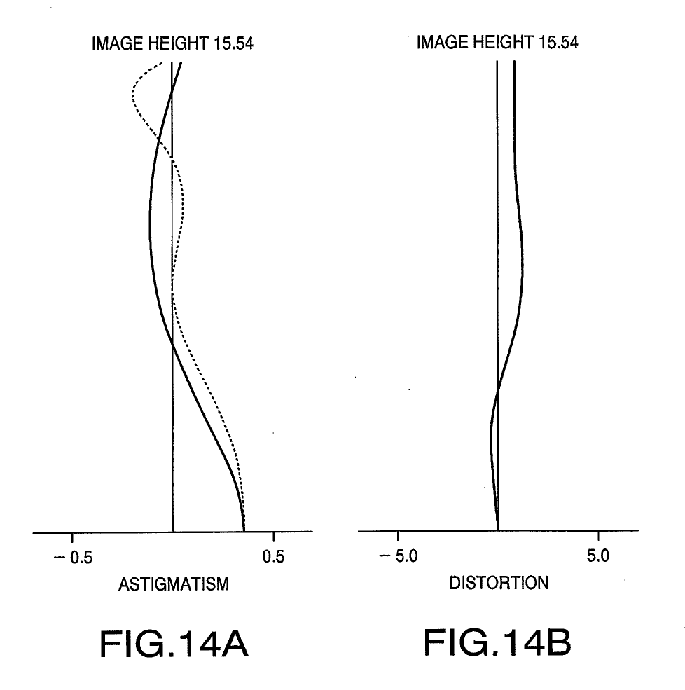

FIG. 14A is a graph illustrating astigmatism caused in the optical projection system 10 according to the fourth example. FIG. 14B is a graph illustrating distortion caused in the optical projection system 10 according to the fifth example.

The following Table 11 shows values of the above mentioned parameters of the optical projection system 10 for each of the first to fifth examples. Table 12 shows values of the above mentioned parameters regarding the conditions (2) to (6) calculated based on the values shown in Table 11. The values relating to the conditions (1) and (7) are calculated based on values of W1, W2 and ft in Table 11.

TABLE 11

| | f1 | f2 | f1ₐ₁ | f1ₐ₂ | f1b | ft |
|---|---|---|---|---|---|---|
| 1^{st} EXAMPLE | 33.628 | −20.534 | 52.069 | 55.862 | −34.426 | 406.595 |
| 2^{nd} EXAMPLE | 33.085 | −25.376 | 48.899 | 57.909 | −38.371 | 321.855 |
| 3^{rd} EXAMPLE | 37.724 | −19.937 | 53.268 | 60.328 | −40.193 | 429.611 |
| 4^{th} EXAMPLE | 30.681 | −15.216 | 44.996 | 36.762 | −34.279 | 68.947 |
| 5^{th} EXAMPLE | 39.464 | −17.877 | 44.085 | 40.876 | −46.728 | 73.841 |

| | D | L1b | EXP1 | W1 | W2 |
|---|---|---|---|---|---|
| 1^{st} EXAMPLE | 152.756 | 55.811 | −62.080 | 62.3 | 75.0 |
| 2^{nd} EXAMPLE | 185.138 | 60.853 | −55.490 | 57.1 | 73.2 |
| 3^{rd} EXAMPLE | 145.876 | 58.394 | −76.704 | 62.2 | 75.0 |
| 4^{th} EXAMPLE | 95.076 | 30.425 | −34.584 | 55.8 | 74.3 |
| 5^{th} EXAMPLE | 139.932 | 34.742 | −66.470 | 57.5 | 73.1 |

TABLE 12

| | condition | condition | condition | condition | condition |
|---|---|---|---|---|---|
| | (2) | (3) | (4) | (5) | (6) |
| 1^{st} | 4.543 | −1.846 | −0.977 | 1.660 | −0.611 |
| EXAMPLE | | | | | |
| 2^{nd} | 5.596 | −1.677 | −0.862 | 1.839 | −0.767 |
| EXAMPLE | | | | | |
| 3^{rd} | 3.867 | −2.033 | −0.939 | 1.548 | −0.529 |
| EXAMPLE | | | | | |
| 4^{th} | 3.099 | −1.127 | −0.895 | 0.992 | −0.496 |
| EXAMPLE | | | | | |
| 5^{th} | 3.546 | −1.684 | −0.845 | 0.880 | −0.453 |
| EXAMPLE | | | | | |

As shown in Table 12, all of the optical projection systems 10 according to the first to fifth examples satisfy the above mentioned conditions (1) to (7). As shown in FIGS. 6A, 6B, 8A, 8B, 10A, 10B, 12A, 12B, 14A and 14B, the optical projection device 10 according to each of the first to fifth examples suitably corrects the astigmatism and distortion. Although, in each of the first to fifth examples, the distortion has a changing region where the distortion slightly changes, the changing region does not badly affects the quality of the image to be projected. The reason is that an effective region on the second optical system L2 lies within a range having relatively large image heights (e.g., a range from the image height of 6 mm to the periphery of the second optical system L2). It is understood that the quality of the image is not affected as long as the distortion does not change in the range having relatively larger image heights.

As described above according to the embodiment, it is possible to downsize or reduce the thickness of projection devices while maintaining the high optical performance.

This application claims priority of Japanese Patent Application No. P2006-180939, filed on Jun. 30, 2006. The entire subject matter of the application is incorporated herein by reference.

What is claimed is:

1. An optical projection system for a rear projection type projection device, comprising:
a display device having a rectangular display area forming an image to be projected on a screen of the projection device;
a first optical system that has a positive power in total and has a first lens group and a second lens group arranged in this order from a display device side, the first lens group and the second lens group having a positive power and a negative power, respectively;
a second optical system having a reflective surface having a negative power;
a first deflecting system that directs a light beam emerging from the first optical system to the second optical system;
wherein the first deflecting system is located over the first optical system in a cross sectional plane including a first axis extending in a vertical direction in a normal use state of the projection device and passing through a center of the screen and including a second axis intersecting perpendicularly with the screen and passing through the center of the screen,
wherein the first deflecting system deflects the light beam in a direction moving away from the screen to direct the light beam to the second optical system,
wherein the optical projection system satisfies conditions:
6.0>D/f1>2.6
−1>EXP1/f1>−2.2
where D represents a distance between a rearmost surface of the first optical system and the second optical system, f1 represents a focal length of the first optical system, and EXP1 represents a distance between the rearmost surface of the first optical system and an exit pupil of the first optical system.

2. The optical projection system according to claim 1,
wherein the display device and at least a part of the first optical system are located along a longitudinal direction of the screen,
wherein the optical projection system further comprises a second deflecting system that deflects the light beam emerging from the at least a part of the first optical system.

3. The optical projection system according to claim 1, wherein the optical projection system satisfies a condition:
−1.2<f1/f1b<−0.8
where f1b represents a focal length of the second lens group.

4. The optical projection system according to claim 1,
wherein the optical projection system satisfies a condition:
2>L1b/f1>0.7
where L1b represents a distance between the rearmost surface of the first lens group and a rearmost surface of the second lens group.

5. The optical projection system according to claim 1, further comprising a third deflecting system that directs the light beam emerging from the second optical system to the screen.

6. The optical projection system according to claim 5,
wherein the third deflecting system is positioned to satisfy a condition:
75°<θ<86°
where θ represents an angle which a normal to the third deflecting system forms with respect to a normal to the screen.

7. The optical projection system according to claim 1,
wherein the reflective surface of the second optical system is formed to be a rotationally-symmetrical aspherical surface.

8. The optical projection system according to claim 7, wherein a rotation axis of the rotationally-symmetrical aspherical surface of the second optical system coincides with an optical axis of the first optical system when an optical path of the optical projection system is developed.

9. The optical projection system according to claim 1, wherein the first optical system is configured to be a telecentric system on the display device side.

10. A projection device, comprising:
a light source;
the optical projection system according to claim 1, a light beam emitted by the light source entering the projection optical system; and
the screen onto which the image formed by the display device of the projection optical system is projected in such a manner that the light beam from the projection optical system proceeds to the screen in a slanting direction from a rear side in the projection device.

11. An optical projection system for a rear projection type projection device, comprising:
a display device having a rectangular display area forming an image to be projected;
a first optical system that has a positive power in total and has a first lens group and a second lens group arranged in this order from a display device side, the first lens group and the second lens group having a positive power and a negative power, respectively;
a second optical system having a reflective surface having a negative power; and
a first deflecting system that directs a light beam emerging from the first optical system to the second optical system,
wherein the first lens group includes a third lens group having a positive power, a fourth lens group having a positive power, and an aperture stop located between the third and fourth lens groups,
wherein when an optical path of the projection device is developed, a rotation axis of the first optical system formed to be rotationally-symmetrical about the rotation axis of the first optical system coincides with a rotation axis of the second optical system formed to be rotationally-symmetrical about the rotation axis of the second optical system,
wherein the optical projection system is configured to satisfy conditions:
50°<W1<70°<W2
6.0>D/f1>2.6
−1.2<f1/f1b<−0.8
−0.9<f2/f1<−0.2
ft>0
where W1 represents a minimum incident angle of right rays incident on the screen, W2 represents a maximum incident angle of the right rays incident on the screen, D represents a distance between a rearmost surface of the first optical system and the second optical system, f1 represents a focal length of the first optical system, f1b represents a focal length of the second lens group, f2 represents a focal length of the second optical system, and ft represents a total focal length of the second lens group and the fourth lens group.

12. The optical projection system according to claim 11, wherein the first optical system is configured to be a telecentric system on the display device side.

13. A projection device, comprising:
a light source;
the optical projection system according to claim 11, a light beam emitted by the light source entering the projection optical system; and
the screen onto which the image formed by the display device of the projection optical system is projected in such a manner that the light beam from the projection optical system proceeds to the screen in a slanting direction from a rear side in the projection device.
